(19) United States
(12) Patent Application Publication
(10) Pub. No.: US 2006/0228110 A1
(43) Pub. Date: Oct. 12, 2006

(54) Camera system

(75) Inventor: Takehiko Senba, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/397,678

(22) Filed: Apr. 5, 2006

(30) Foreign Application Priority Data
Apr. 12, 2005 (JP) 2005-114694

(51) Int. Cl. G03B 17/00

(52) U.S. Cl. 396/529

(57) ABSTRACT

The present invention provides a camera system including a camera head and a camera body provided with a disengagement operation detecting section and a recording control section. The disengagement operation detecting section detects operation of disengaging the camera head from the camera body in the state where image information can be transmitted from the camera head to the camera body. The recording control section stops recording of image information in response to operation of disengaging the camera head from the camera body being detected by the disengagement operation detecting section.

### BACKGROUND OF THE INVENTION

1. Field of the Invention

The present invention relates to a camera system having a camera head which is provided with an image taking optical system and an image pickup device to generate image information, and a camera body which receives image information from the camera head detachably attached thereto to record image information in a recording medium.

2. Description of the Related Art

In the movie industry, one frame (cut) is taken from a movie film as a still image to be used, for example, as a poster. As it is convenient for a user to be able to take a still image from a moving image, some video cameras are configured to be able to take a still image from a moving image (for example, see Japanese Patent Application Publication No. 6-189169). The technique disclosed in Japanese Patent Application Publication No. 6-189169 teaches obtaining high-quality still image of fine pixels by incorporating shooting at a fast shutter speed into a movie shooting. However, this technique has a problem in which a high-capacity recording medium is required for a high-quality image of fine pixels included in a moving image. Thus, there is a recent trend that a high-capacity medium such as a hard disc or a DVD which are in common use for computers, is used to record a moving image. Using such a high-capacity medium allows recording of large amounts of image data and thereby storing various image information in one recording medium.

Amid the situation in which large amounts of image information can be stored in one recording medium, concerns are that all the image information recorded in one recording medium will be lost if the recording medium is mistakenly taken out during recording. Thus, some video cameras are provided with protection functions. For example, Japanese Patent Application Publication No. 2001-143371 teaches locking mechanism to prevent pulling out of a recording medium during recording, and Japanese Patent Application Publication No. 9-231683 teaches a protection function to protect a writing head against impact or vibration when an image information recording apparatus falls or is subject to vibration, thereby preventing destruction of image data.

However, due to the recent trend for a digital camera capable of movie shooting, in one type of such a digital camera, a camera head is separated from a camera body and is attached to the camera body during shooting. In a camera system of such a digital camera, if a camera head is disengaged from a camera body during recording of image information, all the image information in a recording medium including the one being recorded will be lost even if the protection function described above is provided. This is because, when a camera head is disengaged from a camera body while image information is recorded, connection is instantly cut between the electric contacts of a camera head and those of a camera body and thus the surge voltage with large peak-to-peak values is applied from the electric contacts to the inner circuits of both the camera head and the camera body.

### SUMMARY OF THE INVENTION

The present invention has been made in view of the above circumstances, and provides a camera system which, even when a camera head is disengaged from a camera body while image information is recorded in the camera body, prevents destruction of the image information in a recording medium including the image information being recorded.

A camera system of the present invention has a camera head which is provided with an image taking optical system and an image pickup device to generate image information, and a camera body which receives image information from the camera head detachably attached thereto to record image information in a recording medium, the camera system including;

a disengagement operation detecting section which detects operation of disengaging the camera head from the camera body in the state where image information can be transmitted from the camera head to the camera body; and

a recording control section which stops recording of image information in response to operation of disengagement of the camera head being detected by the disengagement operation detecting section.

Therefore, the disengagement operation detecting section detects operation of disengagement of the camera head before it occurs, and upon the detection the recording control section stops recording of image information.

As recording of image information is stopped before disengagement of the camera head, it is possible to prevent the case where application of surge voltage to the inner circuits upon disengagement of the camera head results in destruction of recording of image information being recorded or already recorded in a recording medium such as DVD.

Preferably, the camera body includes a locking button and a fastening unit which is adapted to fasten the camera head to the camera body so that the camera head cannot be disengaged, and to allow the camera head to be disengaged from the camera body by operation of the locking button, and the disengagement operation detecting section may detect the operation of the locking button.

Accordingly, the recording control section is informed of operation of the locking button for disengaging the camera head from the camera body, through the disengagement operation detecting section, and stops recording of image information before the camera head is disengaged.

In other words, even if the camera head is disengaged from the camera body during image information is recorded, destruction of image information can be prevented including the one being recorded.

More preferably, the fastening unit is adapted to allow the camera head to be disengaged from the camera body, in response to a full press of the locking button up to a predetermined position, and the disengagement operation detecting section detects a half press of the locking button prior to the full press.

Even when the locking button is fully pressed in one action, as the disengagement operation detecting section detects the half press of the locking button and informs the recording control section of the detection, information recording is stopped before the camera head is disengaged from the camera body.

It is also preferable that the camera head and the camera body respectively include image information transmitting electric contacts which transmit image information while the camera head is attached to the camera body, and a disengagement detecting electric contact whose state changes before the image information transmitting electric contacts become electrically discontinuous, in response to operation of disengaging the camera head from the camera body, and that the disengagement operation detecting section detects the change of the disengagement detecting electric contact.

Even when the camera head is rotated to be disengaged while image information transmitting electric contacts are electrically continuous, the state of the disengagement detecting electric contacts change earlier than image information transmitting electric contacts and the change is detected by the recording control section. Accordingly, it is possible to prevent the case where the camera head is disengaged while image information is transmitted through electric contacts.

It should be also noted that change in the state of the disengagement detecting electric contact is applied to both a case where the disengagement detecting electric contact becomes detached from its counterpart in response to operation of disengaging the camera head from the camera body, and a case where the disengagement detecting electric contact is detached from its counter part when the camera head is attached to the camera body and becomes in contact with its counterpart in response to disengaging operation.

### BRIEF DESCRIPTION OF THE DRAWINGS

FIG. 1 is a perspective external view of a camera system viewed obliquely from above, according to an embodiment of the present invention;

FIG. 2 is a schematic sectional view illustrating an internal configuration of the periphery of a locking button according to the embodiment;

FIG. 3 illustrates a process performed by a camera body CPU to stop information recording.

FIG. 4 illustrates a configuration for activating a release switch without fail before a camera head is disengaged from a camera body;

FIG. 5 illustrates a configuration of electric contacts for transmitting image information and electric contacts for detecting disengagement which are provided on both the camera head and the camera body; and

FIG. 6 shows a process performed by the camera body CPU to stop information recording.

### DETAILED DESCRIPTION OF THE INVENTION

An embodiment of the present invention will be described below with reference to the attached drawings.

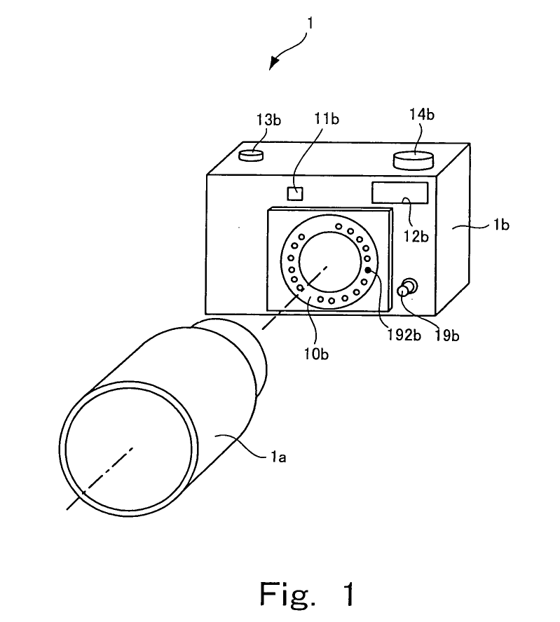

FIG. 1 is a perspective external view of a camera system 1 viewed obliquely from above according to the embodiment of the present invention.

FIG. 1 shows that a camera head 1a is about to be detachably attached to a camera body 1b provided with an image taking optical system and an image pickup device which receives image signals from the camera head 1a to perform signal processing.

As shown in FIG. 1, a head mounting section 10b having multiple mounting contacts is disposed in the substantial center of the camera body 1b, so that a rear end of the camera head 1a can be attached to the head mounting section 10b. Although not shown in FIG. 1, the rear end of the camera head 1a and the head mounting section 10b respectively have three or four claws formed thereon so as to be engaged with each other in a bayonet mount configuration.

Accordingly, when the rear end of the camera head 1a is attached to the head mounting section 10b by being rotated and engaged therein, the camera head 1a is securely engaged with and at the same time is electrically connected with the camera body 1b, through connection between multiple mounting contacts.

In the camera system 1, the camera body 1b is provided with a battery which supplies power to the camera body 1b, and to the camera head 1a through electric contacts out of multiple mounting contacts respectively provided in the camera body 1b and the camera head 1a. When the camera head 1a receives power supplied from a battery in the camera body 1b through the electric contacts, both the camera head 1a and the camera body 1b enter into operating state.

Additionally, a release button 13b and a mode dial 14b are provided on the top of the camera body 1b. Image taking operation is performed by selecting a shooting mode using the mode dial 14b and then by pressing the release button 13b. Upon image taking operation, image information is transmitted from the camera head 1a through the electrical contacts of the head mounting section 10b to the camera body 1b. The mode dial 14b includes, other than the shooting mode, items such as replay mode and power ON/OFF switch, and is rotated when selecting one of the items. The camera body 1b also has AWB sensor 11b and flash emitting window 12b on its front.

In the camera system 1 of the present invention, locking button 19b is provided in the camera body 1b. Engaging pin 192b is provided in the head mounting section 10b, which retracts into the camera body 1b in sync with press operation of the locking button 19b.

The engaging pin 192b partly constitutes a bayonet mount configuration provided in the camera system 1 of the present invention. Bayonet mount configuration, which is a well known technique, corresponds to a fastening unit of the present invention.

When the camera head 1a is attached to the camera body 1b, the engaging pin 192b provided in the bayonet mount section advances toward the camera head 1a and is engaged in an opening formed in the camera head 1a. Accordingly, the camera head 1a can be securely fastened to the camera body 1b so as not to rotate relative to the camera body 1b.

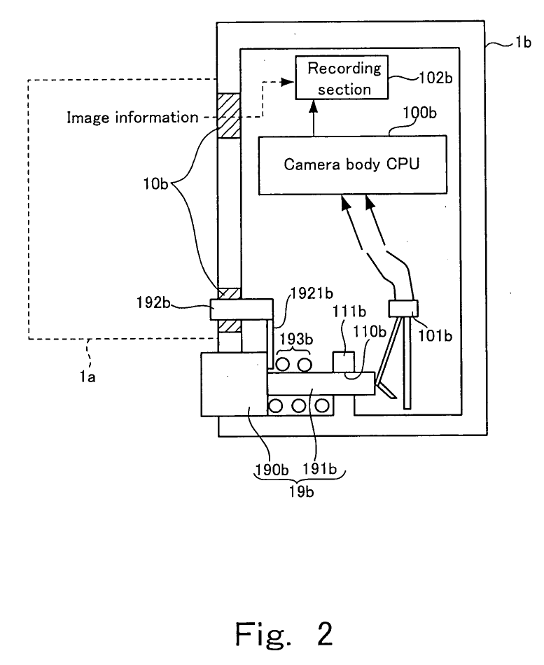

Spring 193b (see FIG. 2) is provided inside the camera body 1b, which press the locking button 19b toward the front of the camera body 1b. In order to disengage the camera head 1a from the camera body 1b, the locking button 19b is pressed down against the spring 193b to disengage the engaging pin 192b from the opening in the camera head 1a.

Now, explanation will be made referring to FIG. 2.

FIG. 2 is a schematic sectional view illustrating an internal configuration of the periphery of the locking button 19b provided in the camera body 1b.

FIG. 2 shows the camera head 1a in the left (represented by dotted lines) which is to be attached to the head mounting section 10b, and the locking button 19b provided in the downside of the head mounting section 10b. The locking button 19b has a two-segmented cylindrical configuration consisting of an operating portion 190b and a fitting portion 191b in which the operating portion 190b has larger radius than the fitting portion 191b. The operating portion 190b is pressed by the spring 193b, which is wound around the fitting portion 191b, toward the front of the camera body 1b to protrude therefrom. The fitting portion 191b is fitted into an opening 110b formed in fixed section 111b of the camera body 1b so as to allow the fitting portion 191b to slidably move. Additionally, the spring 193b is arranged between the operating portion 190b and the fixed section 111b, and an engaging piece 1921b provided in the engaging pin 192b is placed in contact with the boundary between the operating portion 190b and the fitting portion 191b. Accordingly, the engaging pin 192b is also urged by the spring 193b toward the front of the camera body 1b to protrude therefrom. Therefore, when the camera head 1a is not attached to the camera body 1b, the engaging pin 192b as well as the locking button 19b are pressed by the spring 193b to protrude from the front of the camera body 1b. When the camera head 1a is rotated to be engaged in a ring groove formed in the head mounting section 10b in order to be attached to the camera body 1b, the engaging pin 192b is at first pressed into the inside of the camera body 1b. As the camera head 1a is further rotated, the opening of the camera head 1a arrives in the position facing the engaging pin 192b to receive the engaging pin 192b. Thus, with the engaging pin 192b fitted into the opening, the camera head 1a is securely engaged with the camera body 1b such that the camera head 1a cannot move relative to the camera body 1b. On the other hand, in order to disengage the camera head 1a from the camera body 1b, the locking button 19b is pressed to retreat the engaging pin 192b into the camera body 1b.

FIG. 2 shows the camera head 1a securely attached to the camera body 1b, in which the engaging pin 192b protrudes from the front of the camera body 1b and is fitted into the opening of the camera head 1a. When image taking operation is preformed under such condition, image information, which is generated in an image pickup device of the camera head 1a, is recorded in a recording medium (not shown) through recording section 102b of the camera body 1b. If the locking button 19b is pressed, during image taking operation, to disengage the camera head 1a from the camera body 1b, release switch 101b provided on the end of the locking button 19b inside the camera body 1b is activated to notify camera body CPU 100b that the camera head 1a is about to be disengaged just before it is disengaged. Upon the notification, the camera body CPU 100b instructs the recording section 102b to stop recording processing.

Accordingly, even when the camera head 1a is disengaged from the camera body 1b during image information recording in a recording medium by the recording section 102b, it is possible to prevent the case where surge voltage is applied from electric contacts on the head mounting section 10b to a recording medium or the like.

In other words, even when the camera head 1a is about to be disengaged from the camera body 1b during recording processing of image information in the camera body 1b, the recording section 102b is caused to stop the recording processing before the camera head 1b is disengaged. Thus, the camera system 1 of the invention can prevent destruction of image information in the recording medium including the information being recorded.

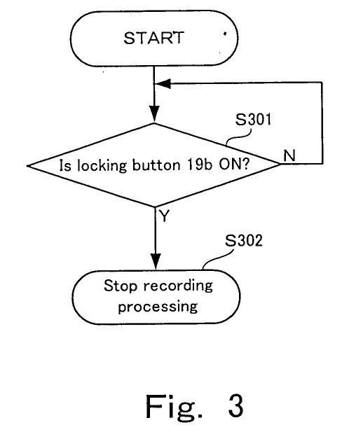

Now, referring to FIG. 3, explanation will be made regarding the camera body CPU 100b which corresponds to a recording control section according to the invention.

FIG. 3 illustrates a process for the camera body CPU 100b to stop information recording.

The process starts when the release button 13b shown in FIG. 1 is pressed.

After the release button 13b is pressed, it is determined in step S301 whether the locking button 19b shown in FIGS. 1 and 2 is pressed or not. When it is determined that the locking button 19b is pressed (Yes), the flow goes to step S302 to stop recording processing in the recording section in FIG. 2.

Accordingly, the camera system 1 of the invention can prevent destruction of image information in the recording medium including the information being recorded, even when the camera head 1a is disengaged from the camera body 1b while image information is recorded by the recording section 102b in the camera body 1b.

However, it should be also noted that the release switch 101b may be activated in sync with disengagement of the camera head 1a from the camera body 1b, depending on the size of relevant parts and fitting condition thereof, if full press of the locking button 19b takes place in one action. Therefore, the camera system should have a configuration to ensure that the release switch is activated before disengagement of the camera head 1a from the camera body 1b.

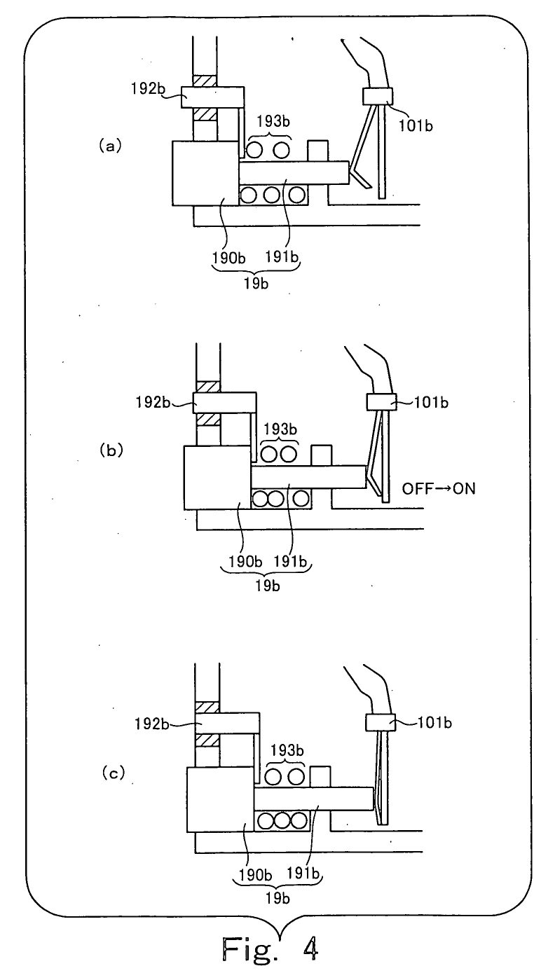

FIG. 4 illustrates such a configuration.

FIG. 4 shows an internal configuration of the camera body 1b; before the locking button 19b is pressed in Part (a) of FIG. 4; when the locking button 19b is half pressed in Part (b) of FIG. 4; and when the locking button 19b is fully pressed in Part (c) of FIG. 4.

As shown in Part (c) of FIG. 4, the size of the operation portion 190b and fitting portion 191b and the position of the fixed section 111b (see FIG. 2) are configured such that disengagement of the camera head 1a is enabled only after the locking button 19 is fully pressed and the engagement pin 192b becomes flush with the front of the camera body 1b.

In other words, the camera head 1a can be disengaged from the camera body 1b only after the locking button 19b is fully pressed (to reach a predetermined position relative to the release switch 101b) as shown in Part (C) of FIG. 4 according to the invention. In addition, the release switch 101b, which corresponds to a disengagement operation detecting section of the invention, is adapted to detect the position of the locking button 19b when it is half-pressed as shown in Part (b) of FIG. 4.

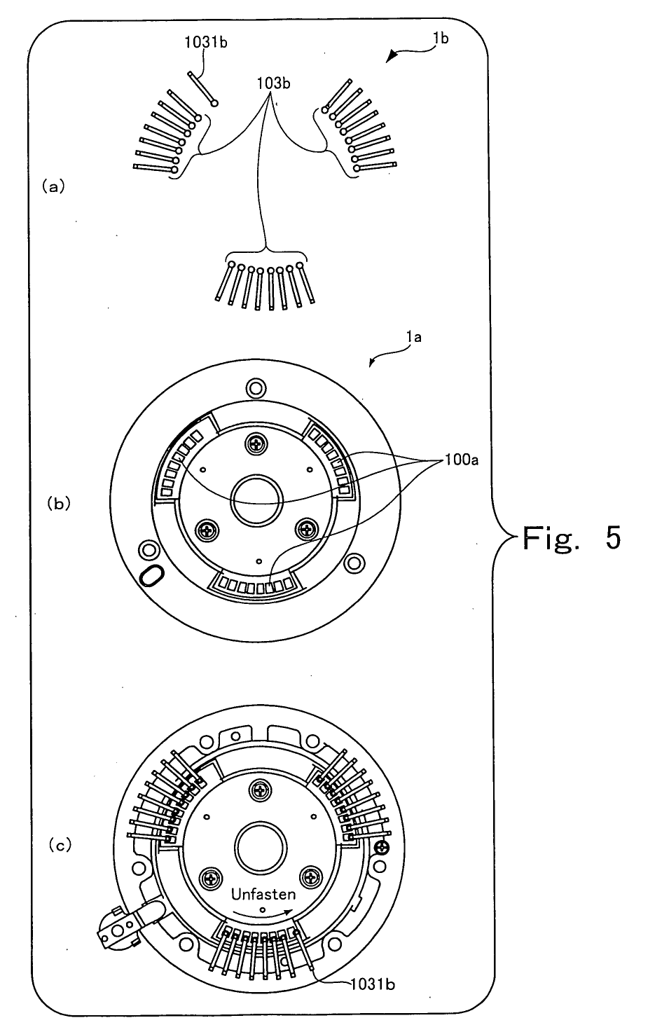

FIG. 5 illustrates a configuration of electric contacts for transmitting image information and an electric contact for detecting disengagement which are provided on both the camera head 1a and the camera body 1b. Part (a) of FIG. 5 shows a configuration of image information transmitting electric contacts 103b and disengagement detecting electric contact 1031b provided in the camera body 1b. Part (b) of FIG. 5 shows a configuration of electric contacts 100a for transmitting image information and detecting disengagement provided in the camera head 1a. Part (c) of FIG. 5 shows the state in which the image information transmitting electric contacts 103b and the disengagement detecting electric contact 1031b of the camera body 1b are in contact with electric contacts 100a of the camera head 1a.

As shown in Part (a) of FIG. 5, spacing between the disengagement detecting electric contact 1031b and one of the image information transmitting electric contacts 103b is adapted to differ from that between the image information transmitting electric contacts 103b. Accordingly, when the camera head 1a is rotated in the direction indicated by the arrow in Part (c) of FIG. 5 to be disengaged from the camera body 1b, the state of the disengagement detecting electric contact 1031b will change (to the off state by being detached) prior to any of other image information transmitting electric contacts 103b, so that the camera body CPU 100b (see FIG. 2) can detect the change in the state of the disengagement detecting electric contact 1031b and cause the recording section 102b (see FIG. 2) to stop recording processing.

In other words, when the camera head 1a is to be disengaged from the camera body 1b in the state where the disengagement detecting electric contact and the image information transmitting electric contacts provided on both the camera head 1a and the camera body 1b are in contact with one another, the disengagement detecting electric contact 1031b of the camera body 1b changes its state to become electrically discontinuous before the image information transmitting electric contacts 103b become electrically discontinuous, such that the camera body CPU 100b, which also corresponds to the disengagement operation detecting section according to the invention, can detect the change.

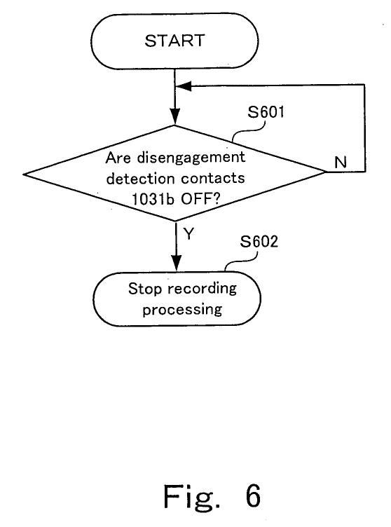

FIG. 6 shows a process performed by the camera body CPU when disengagement detecting electric contact changes its state.

The flow shown in FIG. 6 starts when the release button 13b is pressed.

While image information is recorded in a recording medium after the release button 13b is pressed, in step S601, it is determined whether continuity of the disengagement detecting electric contact 1031b of FIG. 5 is in off state or not, thereby finding if the camera head 1a is about to be disengaged or not. If the disengagement detecting electric contact 1031b is determined to be in off state (Yes), the flow goes to step S602 where recording processing in the recording section 102b (see FIG. 2) is caused to stop.

As described above, even if the camera head 1a is disengaged from the camera body 1b while recording processing is performed in the camera body 1b, the camera system 1 of the invention can prevent destruction of image information recorded in a recording medium including the one being recorded.

Additionally, although Part (a) of FIG. 5 shows only one disengagement detecting electric contact 1031b, the number of disengagement detecting electric contact 1031b may be more than one.

What is claimed is:

1. A camera system having a camera head which is provided with an image taking optical system and an image pickup device to generate image information, and a camera body which receives image information from the camera head detachably attached thereto to record image information in a recording medium, the camera system comprising;
a disengagement operation detecting section which detects operation of disengaging the camera head from the camera body in the state where image information can be transmitted from the camera head to the camera body; and
a recording control section which stops recording of image information in response to operation of disengagement of the camera head being detected by the disengagement operation detecting section.

2. A camera system according to claim 1, wherein the camera body includes a locking button and a fastening unit which is adapted to fasten the camera head to the camera body so that the camera head cannot be disengaged, and to allow the camera head to be disengaged from the camera body by operation of the locking button, and
wherein the disengagement operation detecting section detects the operation of the locking button.

3. A camera system according to claim 2, wherein the fastening unit is adapted to allow the camera head to be disengaged from the camera body, in response to a full press of the locking button up to a predetermined position, and
wherein the disengagement operation detecting section detects a half press of the locking button prior to the full press.

4. A camera system according to claim 1, wherein the camera head and the camera body respectively include image information transmitting electric contacts which transmit image information while the camera head is attached to the camera body, and a disengagement detecting electric contact whose state changes before the image information transmitting electric contacts become electrically discontinuous, in response to operation of disengaging the camera head from the camera body, and
wherein the disengagement operation detecting section detects the change of the disengagement detecting electric contact.
